(19) United States
(12) Patent Application Publication
(10) Pub. No.: US 2011/0143321 A1
(43) Pub. Date: Jun. 16, 2011

(54) Portable multifunctional communication and environment aid for the visually handicapped

(76) Inventors: Nghia Xuan Tran, San Diego, CA (US); Dat Duc Nguyen, Stanton, CA (US)

(21) Appl. No.: 12/654,110

(22) Filed: Dec. 10, 2009

(51) Int. Cl. G09B 21/00

(52) U.S. Cl. 434/114

(57) ABSTRACT

A processor, portable power source and Braille character touchpad with a first column area is described, containing three substantially linearly arranged finger responsive areas corresponding to column representations of a Braille character and an adjacent-offset second column area containing one finger responsive area to indicate a null column. Braille character is input by engaging at least one area of the three substantially linearly arranged finger responsive areas and the one finger responsive area. Alternatively, a Braille touchpad containing six finger responsive areas arranged in two columns corresponding to first and second column representations of a Braille character and an adjacent touch gesture pad is described, containing a plurality of finger and gesture responsive areas. A Braille character is input by engaging at least one of the six finger responsive areas and the plurality of finger and gesture responsive areas. Word processing and command action may be initiated by the gesture pad.

### I. FIELD

The following description relates generally to communication aids for the handicapped, and more particularly a multi-functional environmental aid for the visually handicapped.

### II. BACKGROUND

Visually handicapped (VH) people “read” or “write” using tactile communication means. The most famous means is the Braille system which was devised in 1821 by Louis Braille, a blind Frenchman. Each Braille character or cell is made up of six dot positions, arranged in a rectangle containing two columns of three dots each. A dot may be raised at any of the six positions to form sixty-four (2⁶) permutations, including the arrangement in which no dots are raised. For reference purposes, a particular permutation may be described by naming the positions where dots are raised, the positions being universally numbered 1 to 3, from top to bottom, on the left, and 4 to 6, from top to bottom, on the right. For example, dots 1-3-4 would describe a cell with three dots raised, at the top and bottom in the left column and on top of the right column. In Braille text, dots 1-3-4 represent the letter m. The lines of horizontal Braille text are separated by a space, much like visible printed text, so that the dots of one line can be differentiated from the Braille text above and below. Punctuation is represented by its own unique set of characters. The presence or absence of dots gives the coding for the symbol.

Six-key entry, associating a separate key with each dot position in a Braille cell, is used in both mechanical and electronic devices for generating Braille writing. Mechanical embossers (usually called Braillers) that support six-key entry are rugged but expensive machines (starting at around $500), and can be difficult for children and tiring for anyone. Special-purpose mechanical devices can be used for producing small quantities of embossed Braille in various forms such as stick-on labels, but require additional special paper or output supplies that can only be purchased at specialty low-vision stores and therefore are cost-prohibitive.

Electronic Braille devices produce tactile output indirectly by displaying the file on a refreshable Braille display or printing it with an embosser. The majority of current electronic Braillers utilize six-key entry but there is an increasing number which can be purchased with either a six-key or standard keyboard, as the ability to type on a standard keyboard is perhaps even more important for blind (and visually impaired) persons than it is for sighted persons. Indeed, many blind adults have discovered that once they learn to touch type, they can type faster on a standard keyboard than on a six-key one. However, since a standard computer keyboard has 47 keys and can output 94 separate character codes by employing the Shift key, obviously not all of the keyboard characters can be mapped to the 63 unique cells of the six-dot Braille alphabet.

Further, Braillers are limited in that they only allow “text” transfer. They do not provide any mechanism for assisting in day-to-day functions for the visually handicapped. For example, no Braille-capable device is currently available to allow a VH person to tell the color of an object, or direction, or any other information that is sight-specific. Such information is important for encouraging self-sufficiency for VH persons.

Therefore, there has been a longstanding need in the VH community for systems and methods that provide not only communication capabilities, but also awareness capabilities for the VH. These and other aspects are detailed in the following description.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

Apparatuses are provided to facilitate communication by blind or visually handicapped people. In one aspect, an assistive device for the visually handicapped is provided, comprising: a processor; a portable power source coupled to the processor; and a Braille character touchpad connected to the processor for inputting data, comprising: a first column area containing three substantially linearly arranged finger responsive areas, the arrangement spatially corresponding to column representations of a Braille character; and a second column area adjacent to the first column area containing one finger responsive area offset from the three substantially linearly arranged finger responsive areas, the one finger responsive area operating to indicate a null column action for the column representations of a Braille character, wherein a Braille character is input by selectively engaging at least one area of the three substantially linearly arranged finger responsive areas and the one finger responsive area.

In another aspect, an assistive device for the visually handicapped is provided, comprising: a processor; a portable power source coupled to the processor; and an input pad connected to the processor for inputting data, comprising: a Braille touchpad containing six finger responsive areas arranged in two columns, the arrangement spatially corresponding to first and second column representations of a Braille character; and a touch gesture pad adjacent to the Braille touchpad, containing a plurality of finger and gesture responsive areas, wherein a Braille character is input by selectively engaging at least one of the six finger responsive areas of the Braille touchpad and the plurality of finger and gesture responsive areas of the gesture pad, and wherein at least one of a word processing and command action is initiated by selectively engaging the plurality of finger and gesture responsive areas of the gesture pad.

Methods are provided to facilitate communication by blind or visually handicapped people. In one aspect, a method of Braille character entry on a touch sensitive input pad is provided, comprising: a first pressing of at least one area of three substantially linearly arranged finger responsive areas and a single finger responsive area offset from the three substantially linearly arranged finger responsive areas; and a second pressing of at least one area of the three substantially linearly arranged finger responsive areas and the single finger responsive area offset from the three substantially linearly arranged finger responsive areas, wherein an arrangement of the first pressing corresponds to a first column representation of a Braille character and an arrangement of the second pressing corresponds to a second column representation of the Braille character, wherein a null column action is registered if the single finger responsive area is pressed.

In another aspect, a method for Braille character or command entry on a touch sensitive input pad is provided, comprising: first pressing at least one of six Braille format arranged finger responsive areas on a touchpad; and second pressing a gesture pad to terminate entry of the Braille character or gesturing on the gesture pad to initiate a command.

Systems and means are provided to facilitate communication by blind or visually handicapped people. In one aspect, an assistive device for the visually handicapped is provided, comprising: means for computing; means for providing power; and means for inputting finger motions, comprising: a first column area containing three substantially linearly arranged finger responsive areas, the arrangement spatially corresponding to column representations of a Braille character; and a second column area adjacent to the first column area containing one finger responsive area offset from the three substantially linearly arranged finger responsive areas, the one finger responsive area operating to indicate a null column action for the column representations of a Braille character, wherein a Braille character is input by selectively engaging at least one area of the three finger responsive areas and the one finger responsive area.

In another aspect, an assistive device for the visually handicapped is provided, comprising: means for computing; means for providing power; and means for inputting finger motions, comprising: six finger responsive areas arranged in two columns, the arrangement spatially corresponding to first and second column representations of a Braille character; and a plurality of finger and gesture responsive areas adjacent to the six finger responsive areas, wherein a Braille character is input by selectively engaging at least one of the six finger responsive areas and the plurality of finger and gesture responsive areas, and wherein at least one of a word processing and command action is initiated by selectively engaging the plurality of finger and gesture responsive areas.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

Other aspects of the disclosure are found throughout the specification.

### BRIEF DESCRIPTION OF THE DRAWINGS

FIG. 1 shows a high level block diagram of an exemplary system.

FIG. 2 shows another high level block diagram of an exemplary system.

FIG. 3 shows a detailed block diagram of the exemplary system of FIG. 1.

FIG. 4 shows a block diagram of a segregation of exemplary processes.

FIG. 5 depicts an exemplary commercial embodiment.

FIG. 6 depicts another exemplary commercial embodiment.

FIGS. 7A and 7B illustrate the English Braille alphabet in dot and columnar cell formats.

FIG. 8 depicts an exemplary finger gesture configuration, the “Braille M-Touch keyboard.”

FIGS. 9A-9C depict English Braille input of the alphabet letters a-c, respectively, using the exemplary Braille M-Touch keyboard of FIG. 8.

FIG. 10 depicts the tactile dot placement of another exemplary finger gesture input configuration, the “Braille finger gesture pad”.

FIG. 11 depicts the relative sensor placement corresponding to the tactile dot placement of FIG. 10.

FIGS. 12A-12C depict English Braille input of the alphabet letters a-c, respectively, using an exemplary “Braille finger gesture pad.”

FIGS. 13A-13F depict English Braille input of directional keyboard commands, using an exemplary “Braille finger gesture pad.”

FIGS. 14A-14F depict English Braille input of page access keyboard commands, using an exemplary “Braille finger gesture pad.”

FIGS. 15A-15F depict English Braille input of special keyboard commands, using an exemplary “Braille finger gesture pad.”

FIGS. 16A-16F depict English Braille input of insertion/edit keyboard commands, using an exemplary “Braille finger gesture pad.”

FIG. 17 illustrates various possible Personal Digital Assistant (PDA) features in an exemplary embodiment.

FIG. 18 shows a block diagram illustrating the connection of a 3-D magnetic sensor and a 3-D acceleration sensor to the processor in an exemplary embodiment.

FIG. 19 depicts a flow chart showing a possible approach for pitch, roll and yaw angle determination and output.

FIG. 20 depicts an example of calculations that can be used to determine pitch, roll and yaw angles from sensor data.

FIG. 21 depicts another example of calculations that can be used to determine pitch, roll and yaw angles from sensor data.

FIG. 22 depicts an exemplary device measurement function in one mode of operation.

FIG. 23 illustrates the connections of a color sensor and LED components to the processor in an exemplary embodiment.

FIG. 24 depicts an obstacle recognition algorithm for aid in walking.

FIG. 25 depicts an exemplary compass/obstacle finger message module.

FIG. 26 depicts aid in walking (recognition of a block or obstacle).

FIG. 27 depicts aid in walking (recognition of a step or hole).

FIG. 28 depicts aid in walking (recognition of a door, wall or opening).

FIG. 29 shows a block diagram of a prototype exemplary system.

FIG. 30 shows a block diagram of another prototype exemplary system.

### DETAILED DESCRIPTION

Various systems and methods are described for enabling blind or visually impaired persons to obtain needed information, such as time, calendar, alarm, navigation direction, ambient light and temperature conditions, as well as take or receive notes, etc., all in a hand held compact device. The exemplary device can also be configured to have digital storage and digital audio capabilities to store data, voice and music files, and record and play back audio. In some embodiments, the device may be connected to a personal computer (PC) for uploading and downloading files. The exemplary device can also be used by sight-abled users, particularly for learning Braille, etc.

Introduction

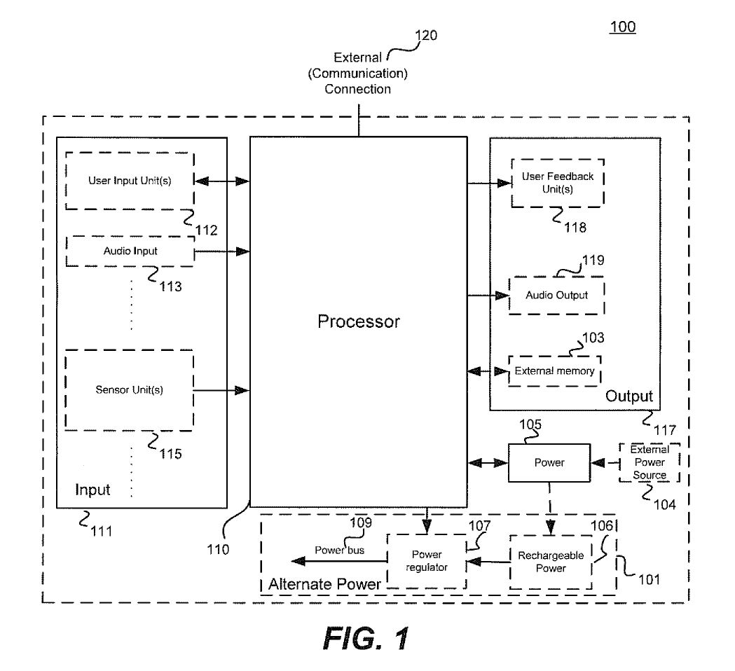

FIG. 1 shows a high level block diagram of an exemplary system 100. As shown, processor 110 of the exemplary system 100 may receive user input via input module 111, which may comprise any one or more of (tactile) user input unit(s) 112, audio input 113, and data input from sensor unit(s) 115 and so forth. The processor 110 processes and stores the data input using internal memory (not shown) and outputs the data via output module 117, which may comprise any one or more of user feedback unit(s) 118, audio output 119 and so forth. Alternatively, data may be read from or written to an external memory 103 in addition to the internal memory inherent in the processor 110.

The designation of user input unit(s) 112 as input is arbitrary as the input unit(s) 112 may in some embodiments both transmit data to and receive data from the processor 110. It is noted that although FIG. 1 shows singular input components 112, 113 and 115 and singular output components 118 and 119, each of these components can employ more than one input or output unit on the system 100, where such additional components can also be adapted for data input or output as according to design preference. It should be appreciated that more or less and alternative components may comprise input module 111 or output module 117. Examples include and are not limited to visual input, tactile input, display output, or visual output. Optionally, power 105 may be supplied to the processor 110 and various input and output modules via an external power source 104. Additionally, power 105 may be used by the processor 110 in performing the discussed functions, but also to charge an alternate power source 101, which may comprise a rechargeable power source 106. A power regulator 107 may be used, with a power bus 109, to regulate the charging capacity and speed. The exemplary system 100 may be contained in a single device and (optionally) connectable to external devices and systems (not shown) via an external communication connection 120.

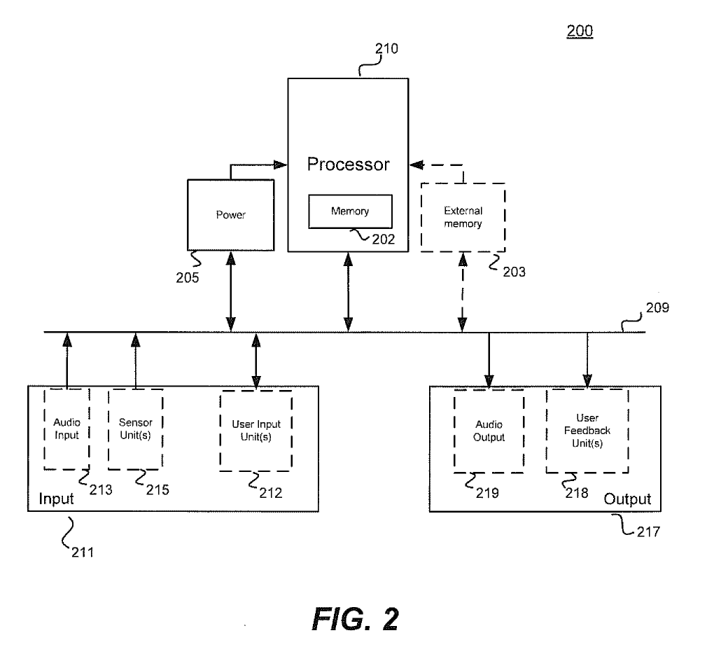

FIG. 2 shows a high level block diagram of an exemplary system 200, facilitated by a power/communication bus 209. In a further variation of the previously discussed system 100, the connections between the discussed components may be facilitated and/or made through a power/communication bus 209. As shown, power 205 can be provided directly to the processor 210 and also provided to the other components via the power/communication bus 209. Processor 210 of the exemplary system 200 may receive user input via input module 211, which may comprise (tactile) user input unit(s) 212, audio input 213, and further data input from sensor unit(s) 215, through the power/communication bus 209. The processor 210 processes and stores the data input using internal memory 202 and outputs the data via output module 217, which may comprise user feedback unit(s) 218 and audio output 219, through the power/communication bus 209. While the processor 210 can inherently contain internal memory 202, external memory 203 may be employed in addition, or as an alternative, to the internal memory 202 as a target for read and write functions by the processor 210. This external memory 203 may also be connected via the power/communication bus 209, or connected directly to the processor 210. It should be appreciated that more or less and alternative components may comprise input module 211 or output module 217. Examples include and are not limited to visual input, tactile input, display output, or visual output, etc.

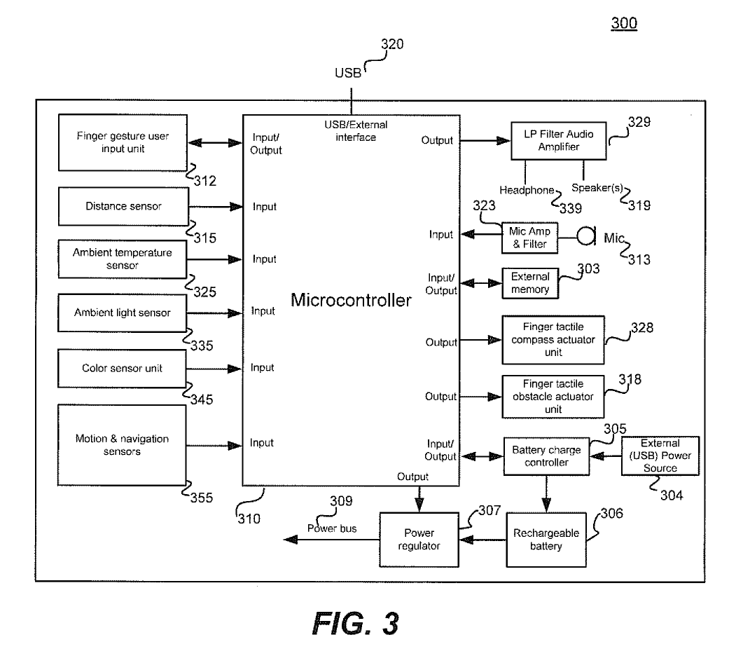

FIG. 3 shows a detailed block diagram of an exemplary communication system 300 comprising a microcontroller 310 that may receive user input via a finger gesture user input unit 312, a microphone 313 for audio input, and further data input from sensor unit(s). The sensor unit(s) may include one or more unit(s) selected from one or a plurality of distance sensor 315, ambient temperature sensor 325, ambient light sensor 335, color sensor unit 345, motion sensor and navigation sensor 355. The designation of finger gesture user input unit 312 as input is arbitrary as the finger gesture user input unit 312 can both transmit data to and receive data from the microcontroller 310. Singular output components such as finger tactile actuator unit 318, finger tactile compass actuator unit 328, speaker(s) 319, and headphone 339 are connected directly or indirectly to microcontroller 310. It is noted that although singular input components 312, 313, 315, 325, 335, 345 and 355 and singular output components 318, 328, 319 and 339 are shown, each of these components can employ more than one input or output unit on the system 300, where such additional components can also be adapted for data input or output described herein.

The microcontroller 310 can be powered by external power 304 (shown here as an optional USB source), controlled by a battery charge controller 305. The battery charge controller 305 can also control the speed and capacity for powering a rechargeable battery 306 and power regulator 307 (connected to a power bus 309). The microcontroller 310 processes the data input and stores the data using inherent internal memory (not shown) or external memory 303 (performing read/write operations) and may output the data via user feedback unit(s) in the form of a finger tactile obstacle actuator unit 318, a finger tactile compass actuator unit 328, and more conventional audio output in the form of a headphone 339 or speaker(s) 319 and so forth. For audio clarity, as shown, the audio signals from the microphone 313 may be processed by a microphone amplifier and filter 323 before being input to the microcontroller 310. Conversely, the audio output signals are passed through a low pass filter and audio amplifier 329 to increase output clarity before being output through the headphones 339 and/or speaker(s) 319. An external port such as a USB port 320 may be configured.

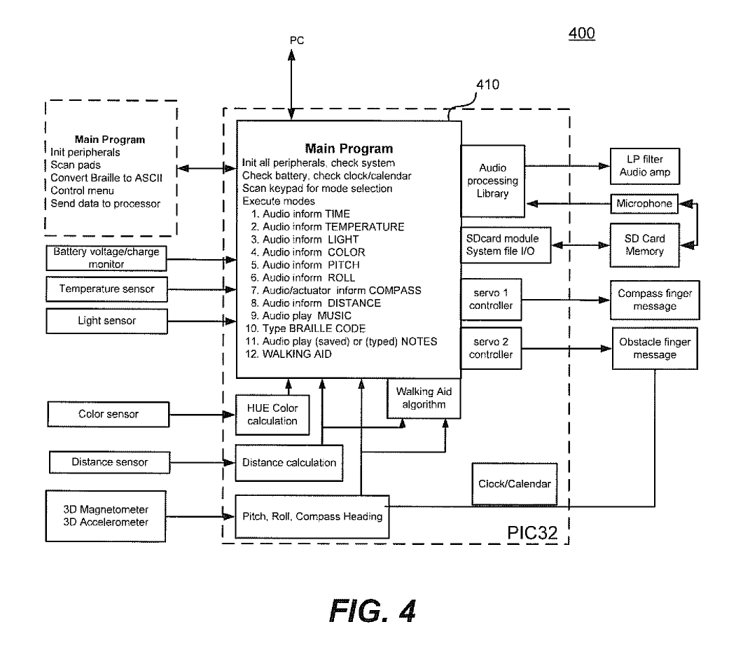

FIG. 4 shows a block diagram 400 showing a segregation of exemplary processes. Main program 410 acts as a housekeeping and control program and can perform initiation of peripherals, etc., and execute various operations shown, such as TIME, TEMPERATURE, COLOR, COMPASS, DISTANCE, etc. Peripheral devices, such as a temperature sensor, light sensor, color sensor, distance sensor, 3-D magnetomer, 3-D accelerometer, finger gesture user input unit or pads, etc., forward their readings/information to the main program 410 for processing temperature readings, calculating hue for color indication, calculating distance, determining the pitch, roll and/or compass headings, informing the user of information audibly, playing music, typing, etc.

In one mode of operation, the information forwarded to the main program 410 can be converted into text format and then passed to an audio processing library (not shown). The audio processing library can act as a voice dictionary matching text with a specific audio voice in the voice library. A part of memory may be reserved for the voice audio library to store several hundred or thousands of pre-recorded voices. In another aspect, the audio processing can act as a text-to-speech engine which is a voice synthesizer to generate voice without the need of a pre-recorded voice library.

As another example of different modes of operation, in notes record mode, for example, the main program 410 can convert input Braille code notes into text and store it in memory. As another example, in notes playback mode, the main program 410 executes a process of converting note text in memory into note voice output to the audio filter and amplifier.

It should be appreciated that various operations can be removed or added without affecting the general functionality of the exemplary implementation. For example, it may not be necessary to filter or amplify audio signals. Conversely, additional operations can be added, for example language translation operations referencing a dictionary/translation file.

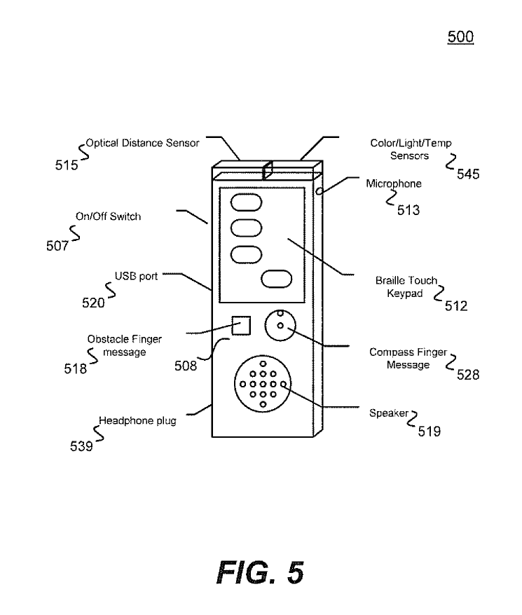

An exemplary commercial embodiment encapsulates the discussed features in a singular small, portable personal digital assistant tool. For example, FIG. 5 depicts an exemplary commercial embodiment 500 comprising an optical distance sensor 515 and a multifunctional color/light/temperature sensor 545 at an end of the device. The microphone 513 may be strategically located at one of the sides of the device, for example, near the top, for optimal recording conditions. The power/battery charging switch 507 may be located on another side or end of the device and an audio output plug 539 (i.e. for headphones) can also be located on one side of the device. For convenience to the user, all of the tactile responsive features may be located on one face of the device. For example, a Braille touch keypad 512 may be positioned near the finger message area 508 providing user ‘finger readable’ information from the obstacle finger message area 518 and compass finger message area 528. The speaker 519 may be positioned on the same face, or an alternate face, as the finger message area 508 or Braille touch keypad 512. Other locations, positions or arrangements about the device may be contemplated according to design preference. For example, an external port such as a USB port 520 may be configured.

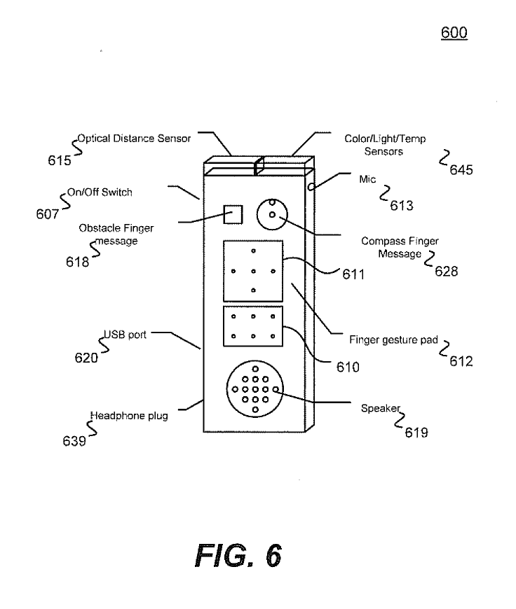

FIG. 6 depicts another exemplary commercial embodiment 600 comprising an optical distance sensor 615 and a multifunctional color/light/temperature sensor 645. Also, the microphone 613 may be strategically located at one of the sides of the device, near the top, for example. The power/battery charging switch 607 may be located on one side or end of the device and an audio output plug 639 (i.e. for headphones) can also be located on one side of the device. For convenience to the user, all of the tactile responsive features may be located on one face of the device. For example, the Braille finger gesture pad 612 comprising the Braille touch pad 610 and touch gesture pad 611 may be positioned at a face of the device. The face may also contain an obstacle finger message area 618 for relaying information to the user from the internal obstacle tactile unit (not shown) and compass finger message area 628 for relaying information to the user from the internal compass tactile unit (not shown). The speaker 619 may be positioned on the same face, or an alternate face of the device. Other locations, positions or arrangements about the device may be contemplated according to design preference. For example, an external port such as a USB port 620 may be configured.

While FIGS. 5 and 6 depict exemplary commercial embodiments having a rectangular housing, it should be recognized that many other and varied housing shapes are contemplated. For example, a commercial embodiment could be configured in a cylindrical or contoured housing, to more ergonomically conform to the user's hand. As an alternative, the commercial embodiment could comprise a housing having non-uniform width, for example similar to three-dimensional oval, hourglass or pyramidal shapes. Similarly the location and arrangement of certain features may be varied without impact to the system performance.

User Text/Command Entry

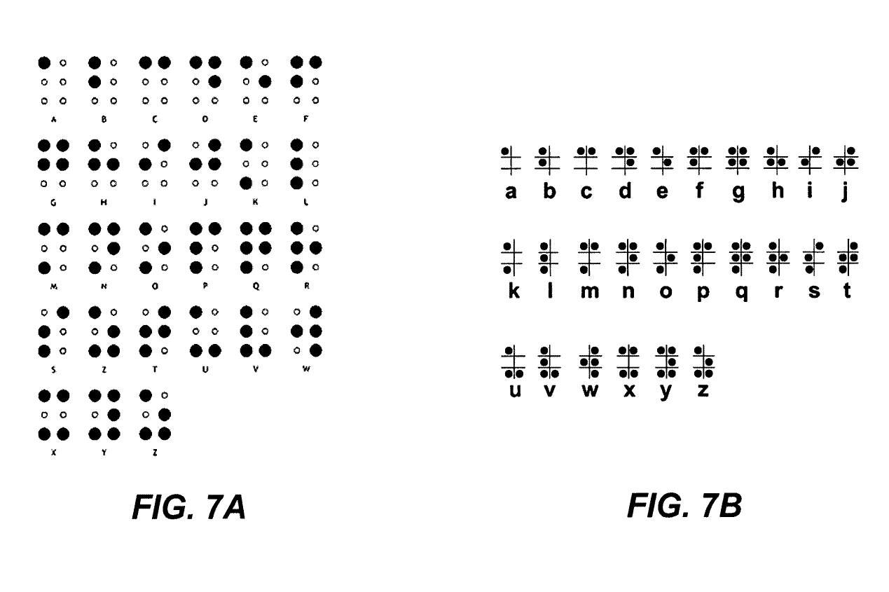

As discussed above, the Braille alphabet comprises varying binary combinations of six dots in two columns and three rows. FIG. 7A illustrates the English Braille alphabet in six dot cell format. FIG. 7B illustrates the English Braille alphabet in a two by three cell format. The positions of each cell are universally numbered 1 to 3, from top to bottom, on the left, and 4 to 6, from top to bottom, on the right. FIG. 7B is instructive in showing how any English Braille alphabet can be formed from a sequence (col. 1→col. 2) of the cells.

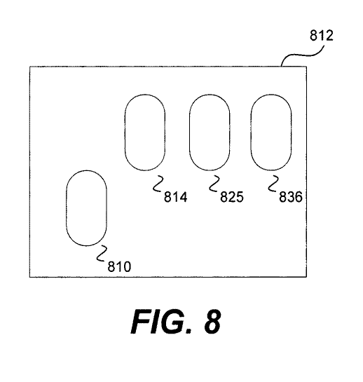

FIG. 8 depicts an exemplary finger gesture configuration, the “Braille M-Touch keyboard” 812. The Braille M-Touch keyboard 812 comprises four pads 814, 825, 836 and 810, which can correspond to the index, middle and ring fingers and thumb of the user, respectively. The 1, 2 and 3 positions in the left column of the six-dot Braille cell correspond to the three pads 814, 825 and 836 laid in horizontal row form. The three pads 814, 825 and 836 also correspond to the 4, 5 and 6 positions in the right column of the six-dot Braille cell. Pad 810 is used by the user to indicate a null entry. This compact four pad entry method condenses the movements and pads necessary for six-key input methods, but is still similar enough to likely be familiar to many Braille users; thus the M-touch keypad 812 may be readily used by many Braille users.

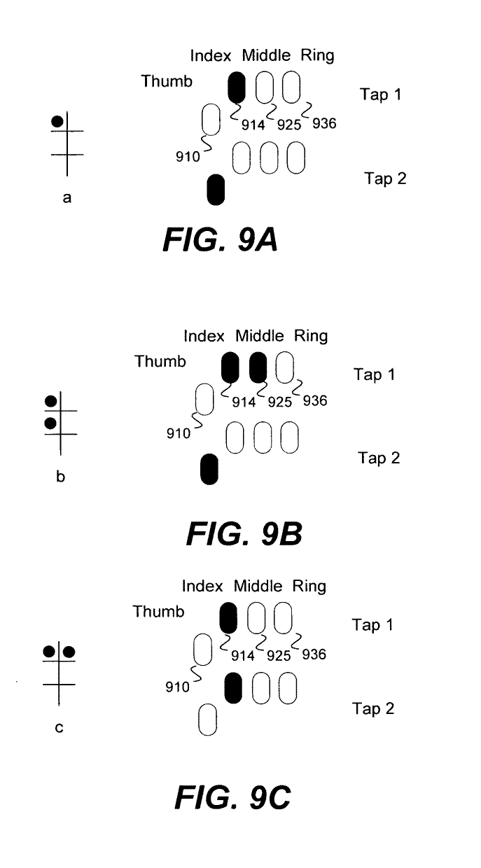

FIGS. 9A-9C depict time sequenced English Braille input of the alphabet letters a-c, respectively, using an exemplary Braille M-Touch keyboard, in which the user taps multiple times to input or type letters. Referring back to FIG. 8, the user's index, middle and ring fingers, on pads 814, 825 and 836 respectively, can be used in a first tap to signify of the 2 and 3 positions in the left column of the six-dot Braille cell. In a second tap, the user's index, middle and ring fingers, on pads 814, 825 and 836, respectively, correspond to the 4, 5 and 6 positions in the right column of the six-dot Braille cell. If no positions are used in a column, the first ‘subscripted,’ or thumb, pad 810 may be used to indicate a null entry value.

For example, with reference to FIG. 9A, the alphabet letter “a” is represented in Braille by a dot in position 1 (left column), with the other positions (rest of left column and right column) empty. Accordingly, only pad 914 needs to be pressed in tap 1, by the user's index finger. For tap 2, the user only needs to press pad 910 with his/her thumb, to indicate that positions 4-6 are empty. Similarly, FIG. 9B shows that the user presses pads 914 and 925 with index and middle fingers in tap 1, and pad 910 with thumb in tap 2, to enter the alphabet letter “b.” FIG. 9C shows how a user would input alphabet letter “c,” by tapping his/her index finger on pad 914 as a first tap (1), and tapping his/her index finger again on pad 914 for tap 2.

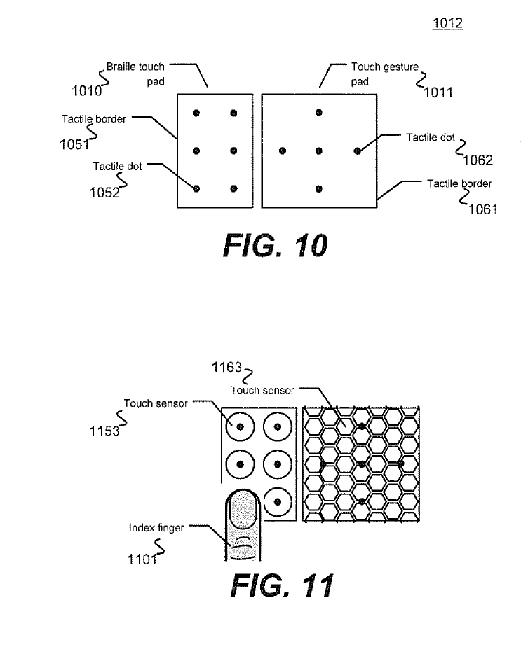

FIG. 10 depicts another exemplary finger gesture configuration, Braille finger gesture pad 1012, employed for user entry of Braille characters. As discussed above, English Braille employs binary combinations of six dot positions corresponding to the 26 letters of the alphabet, punctuation, and some double letter signs and word signs directly, but capitalization and numbers are dealt with by using a prefix symbol. This requires additional sequential entry to convey the correct letter or word sign and often leads to confusion among inexperienced users or may lead to technical issues or lost characters with entry in too quick a succession. Thus in this embodiment, two touch pads are used in combination for faster and clearer character entry. The first “Braille touch pad” 1010 may be enclosed within a tactile border 1051 and contains six tactile dots 1052 in two columns of three dots each. Thus, the Braille touch pad 1010 corresponds in larger part to the traditional Braille entry mode. The second “touch gesture pad” 1011 comprises a tactile border 1061 enclosing four tactile dots 1062 placed in each corner of a diamond and a fifth tactile dot 1062 in the center of the diamond. Entry in the Braille touch pad may largely be focused on one of the six circular areas surrounding the six tactile dots 1052. Similarly, entry in the touch gesture pad may be primarily sensitive around the five tactile dots 1062; however, the entire enclosed tactile area may be employed in touch gesture.

FIG. 11 depicts the relative touch sensor 1153, 1163, placement corresponding to the tactile dot 1052, 1062 placement of FIG. 10. The pads are easily activated and entries made with the pressure produced by, for example, an index finger 1101.

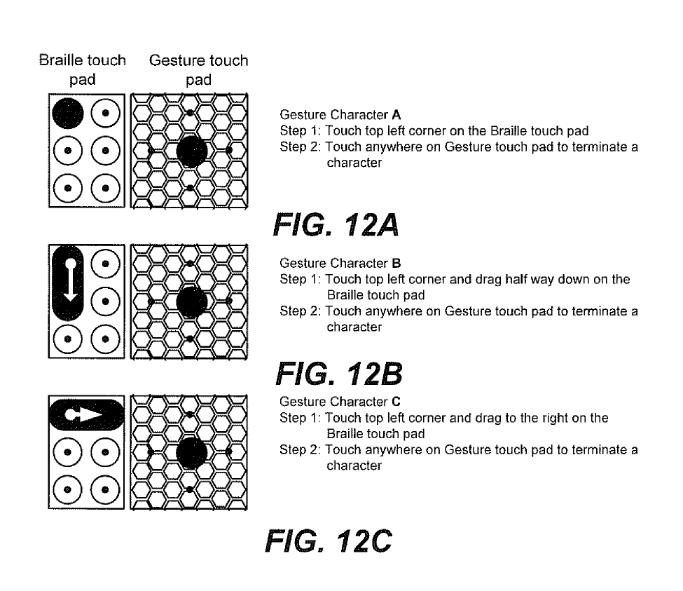

FIGS. 12A-C depict English Braille input of the alphabet letters a-c, respectively, using the exemplary Braille finger gesture pad of FIGS. 10 and 11. The mode of entry based on the exemplary Braille touch pad is very intuitive and based upon the English Braille system. The same representations are used for each letter/character. However, instead of separate sequential or simultaneous pressing/punching of one or a plurality of six positions arranged in a two by three cellular array, the user can connect any plurality of position touches by dragging or trailing the finger on the Braille touch pad. This continuous tactile entry provides increased speed and accuracy in Braille entry, as the user does not have to lift his finger and is not likely to misplace or mis-enter a character, due to the raised tactile dots and continuous tactile sensation. The touch gesture pad may be used to signify termination or request entry of a character into the device memory.

Thus, as shown in FIG. 12A, for gesture character A, the user would first touch the top left corner of the Braille touch pad, and secondly touch anywhere on the gesture touch pad to terminate the character. Thus, as shown in FIG. 12B, for gesture character B, the user would first touch the top left corner of the Braille touch pad and drag the finger halfway down the touch pad to contact the second tactile dot of the same column, and secondly touch anywhere on the gesture touch pad to terminate the character. Thus, as shown in FIG. 12C, for gesture character C, the user would first touch the top left corner of the Braille touch pad and drag the finger across the Braille touch pad to contact the second tactile dot of the same row, and secondly touch anywhere on the gesture touch pad to terminate the character.

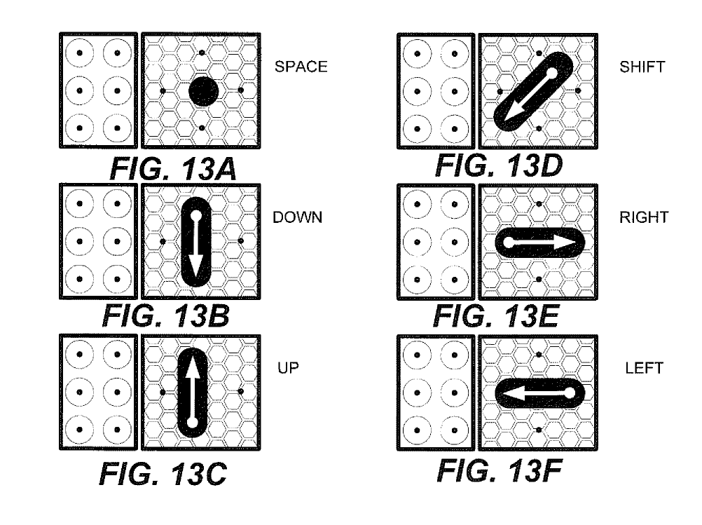

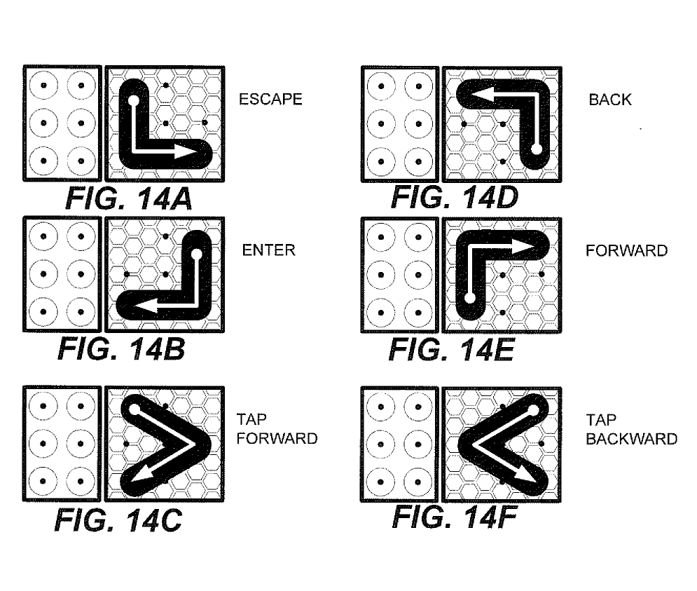

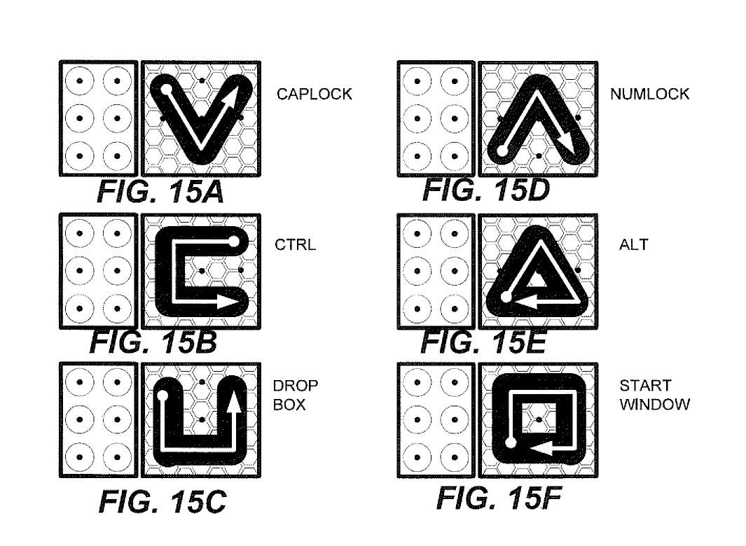

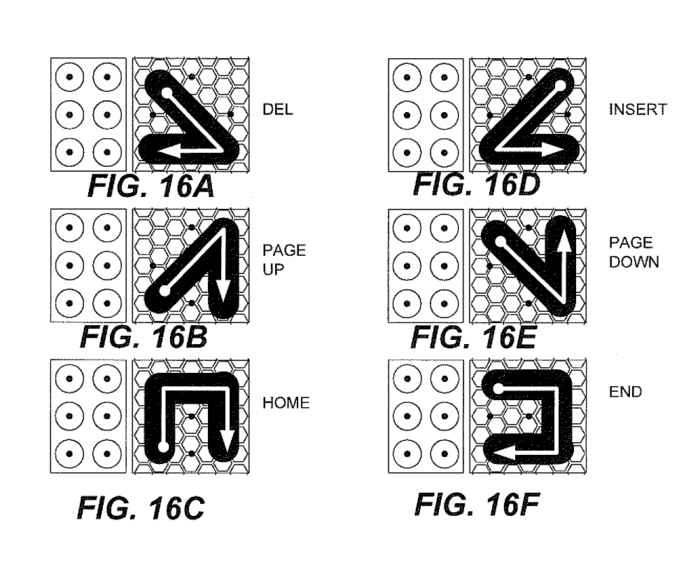

The Braille finger gesture pad can be used to convey an easily learnable collection of special characters and other key commands. For example, by using a series of touches and/or motions FIGS. 13A-13F depict English Braille input of directional keyboard commands, using one possible set of actions. FIGS. 14A-14F depict English Braille input of page access keyboard commands, using another possible set of actions. FIGS. 15A-15F depict English Braille input of special keyboard commands, using yet another possible set of actions. And FIGS. 16A-16F depict English Braille input of insertion/edit keyboard commands, using a different possible set of actions.

Through the use of the exemplary Braille finger gesture pad, the user may input text, characters, letters, numbers to create or edit notes, documents and other textual files. The exemplary Braille finger gesture pad may also be used to control or access features or feature menus of the device. The exemplary Braille finger gesture pad may be further programmable, so that the user may personalize commands and entry combinations that allow for shortcut or ‘home key’ features to be enabled for easier access to device features and capabilities. Such and other modifications to arrive at the desired command or “stroke” and variations thereof using the exemplary Braille finger gesture pad are contemplated.

Assistive Features

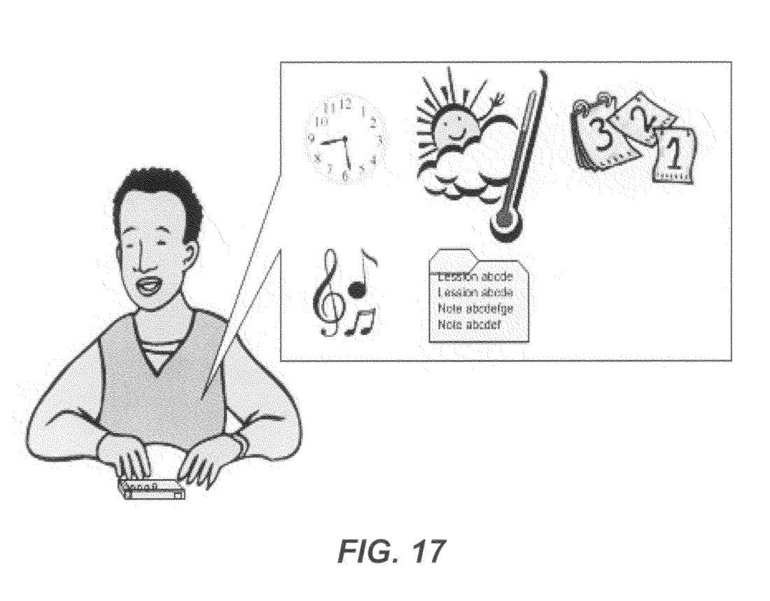

FIG. 17 illustrates various possible Personal Digital Assistant (PDA) features using an exemplary embodiment. Thus, entry of Braille based characters may be used to input and access many Personal Digital Assistant (PDA) features. For example, the user may access time information and alarm functions, obtain temperature and weather information, retrieve and input calendar and scheduling information, access and edit music and text or other word processing files. While some of these features may employ components shared with other assistive features, many configurations are contemplated, including voice command and voice recording.

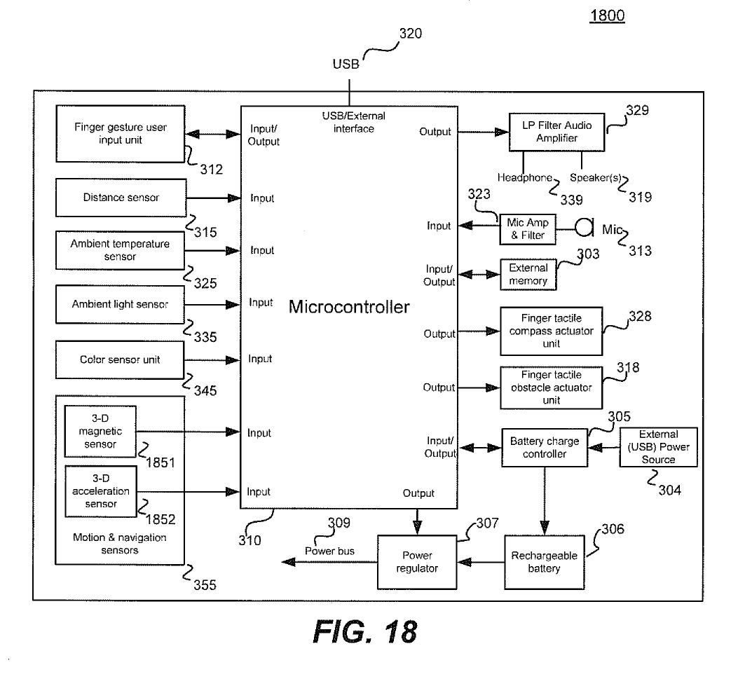

In an alternative embodiment, as shown in FIG. 18, the device may contain a 3-D magnetic sensor 1851 and/or a 3-D acceleration sensor 1852 connected to the processor or microcontroller 310. The 3-D magnetic sensor 1851 and/or a 3-D acceleration sensor 1852 may be used in a variety of assistive functions to enable greater independence for the VH.

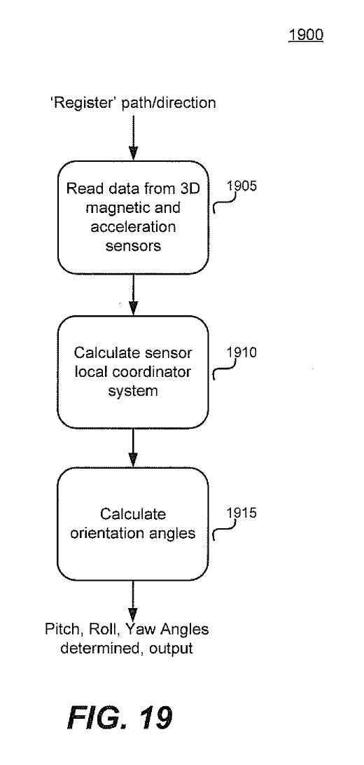

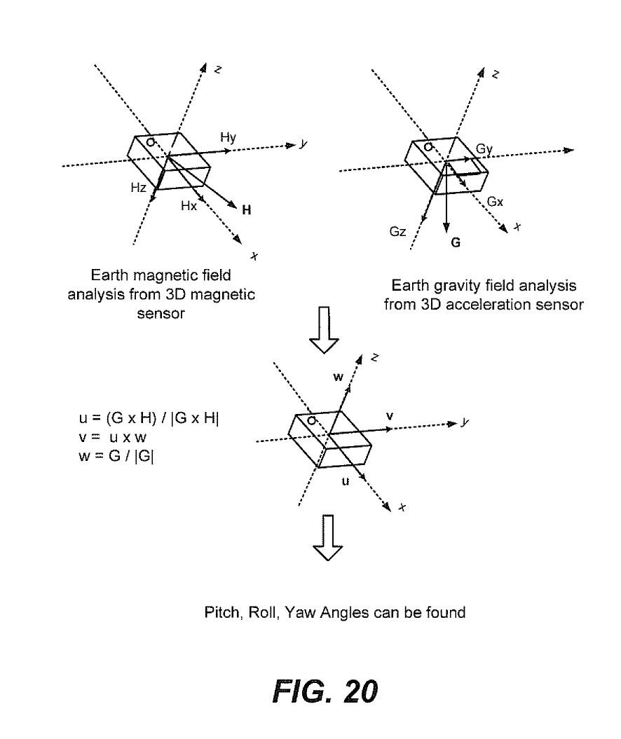

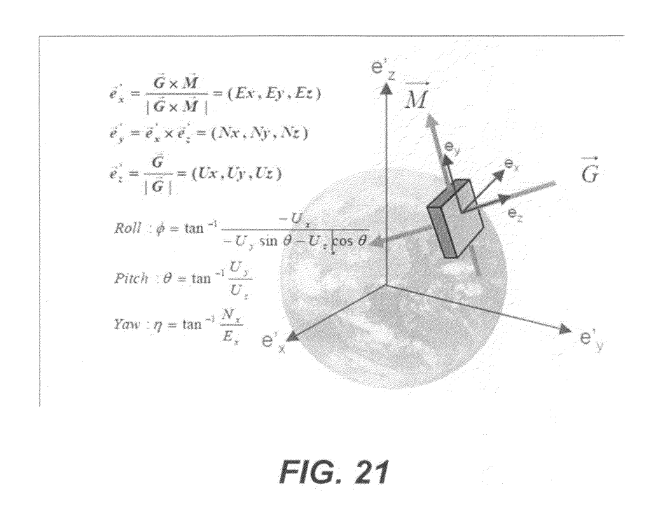

FIG. 19 depicts a flow chart 1900 showing one of several possible approaches for pitch, roll and yaw angle determination and output. Upon an initialization, the path/direction of the user may be ‘registered.’ The exemplary path/direction determination process 1900 contains a read data process 1905, wherein data from a 3-D sensor (e.g. magnetic or acceleration sensor) is read in. Next, the exemplary process 1900 determines or calculates the sensor(s)' local coordinate system 1910. Continuing, the exemplary process 1900 then calculates orientation angles 1915. Based on these inputs and calculations, information such as pitch, roll, yaw, and so forth may be derived for use by the VH. FIG. 20 depicts an example of calculations that can be used to determine pitch, roll and yaw angles from sensor data. FIG. 21 depicts another example of calculations that can be used to determine pitch, roll and yaw angles from sensor data. As should be apparent, other approaches may be used according to design preference.

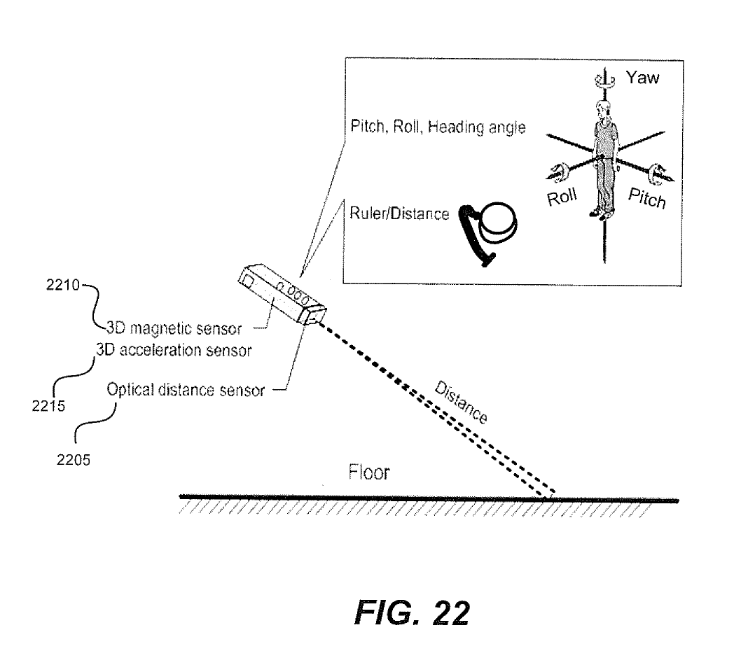

FIG. 22 depicts an exemplary device measurement function in one of several modes of operation. The optical distance sensor 2205, in conjunction with the internal 3-D magnetic sensor 2210 and 3-D acceleration sensor 2215 return the distance value to the user; the user may use this information for assistive walking, ascending or descending a slope or other measurement needs.

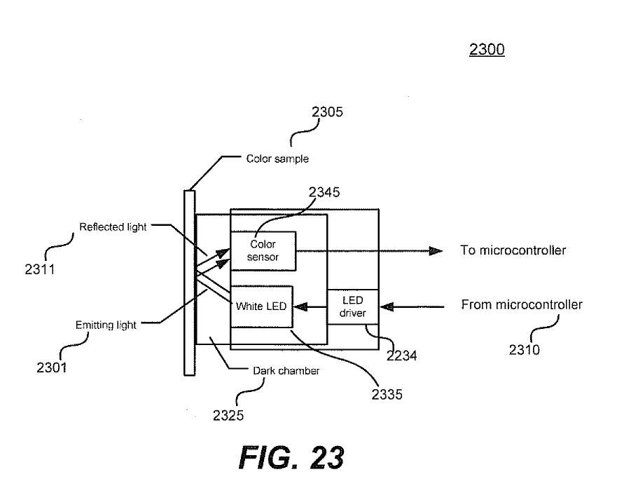

An additional feature of the exemplary device may comprise a color sensing feature. FIG. 23 illustrates an exemplary embodiment with a color sensor 2345 and light generating components (shown here as an LED component) of a color sensing unit 2300, for transmitting color data to a microcontroller/processor 2310. In this embodiment, a color sensor 2345 and white LED 2335 are configured nearby and aimed at a color sample 2305. The user accesses the color sensing feature and thereby activates the microcontroller to signal the LED driver 2334 to power the white LED 2335 and emit white light 2301 towards the top of a dark chamber 2325 covering the color sensor 2345 and white LED 2335. The dark chamber 2325 enables reflection of appropriate light 2311 to be read by the color sensor 2345; the resulting color sensor data is relayed to the microcontroller and processed for reporting to the user. The color may be reported to the user via spoken or symbolic audio means. As should be apparent, the embodiment shown in FIG. 23 is one of several possible ways to detect color and, therefore, other methods or approaches may be used.

The exemplary device color sensing function would be designed to assist a VH in regaining one aspect of their reduced sight. This color sensor feature would enable a user to readily identify for example, the color of produce that are not distinguishable except by color. For example, a user could use the color sensor feature to distinguish between green Granny Smith and red Fuji apples, or to distinguish between red and green grapes, or between lemons and limes.

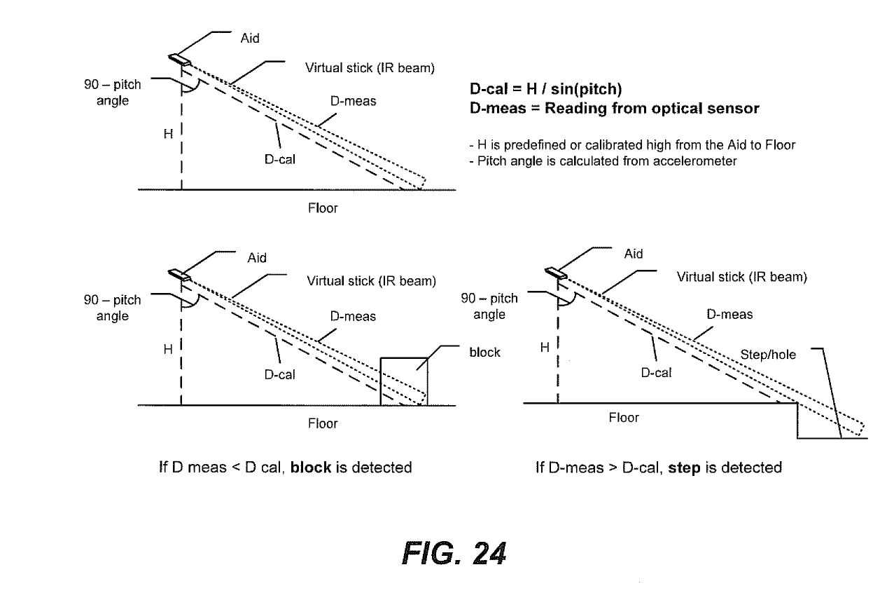

FIG. 24 depicts an obstacle recognition algorithm for aid in walking. A beam, for example, infrared (IR) beam, can be activated at the top of the device, and directed towards the floor when the device is aimed to the floor, thereby acting as a “virtual walking stick.” The distance the beam travels before encountering a solid object (D-meas) is obtained. This D-meas value is compared against calculations made based on the pitch angle data and height of the device. The pitch angle data is relayed from an accelerometer sensor to the microcontroller/processor, while the height (H) may be pre-determined or calibrated (i.e., the user can be trained to hold the device at a certain height relative to their person and the corresponding value pre-programmed or entered into the device), or may vary from use to use (i.e., the user raises or lowers the device until a pre-set or entered height from the floor is reached as recognized by a establishing instance of the beam from the device held in a position perpendicular to the ground). The resulting collected values are computed to calculate D-cal as H divided by the sin of the pitch angle (90-pitch angle). A comparator function then compares D-cal against D-meas. If the values are equal, then the floor or path is level. If D-meas is less than D-cal, a raised obstacle (i.e. a block or hill) is detected. If D-meas is greater than D-cal, a lowered obstacle (i.e. a downward slope, descending step or pothole) is in the user's path.

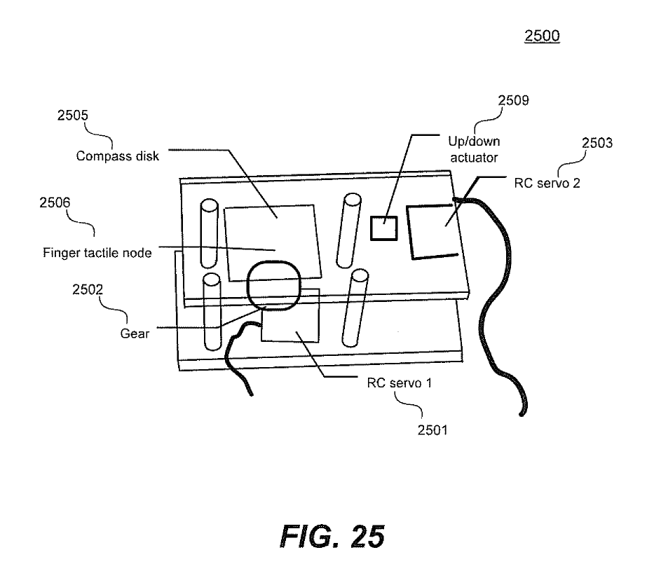

FIG. 25 shows an exemplary compass/obstacle finger message module 2500. In one possible embodiment, a first servo motor 2501 (may be an RC servo motor, as shown) may be connected to drive a compass disk 2505 on which a finger tactile node 2506 corresponds to the arrow tip for due north on a traditional compass. The compass disk 2505 can rotate in positive or minus 180 degrees. Thus a user can receive from the finger tactile node 2506, an indication of the north direction, and understand the heading. A mechanical or other digital solution (shown here as a mechanical gear 2502, although digital computational solutions are also contemplated) may be employed to equate positive and negative angle calculated values to correlate to a traditional compass, i.e. +/−90 degrees to +/−180 degrees. A second servo motor 2503 connects to drive an up/down actuator signal button 2509. The up/down actuator signal button 2509 can be another tactile sensory indicator to the user of position. The position of the actuator may be a binary type value only (i.e. raised, lowered, or level with the device face) or a relational value whereby the position of the actuator suggests a relative elevation of an encountered obstacle.

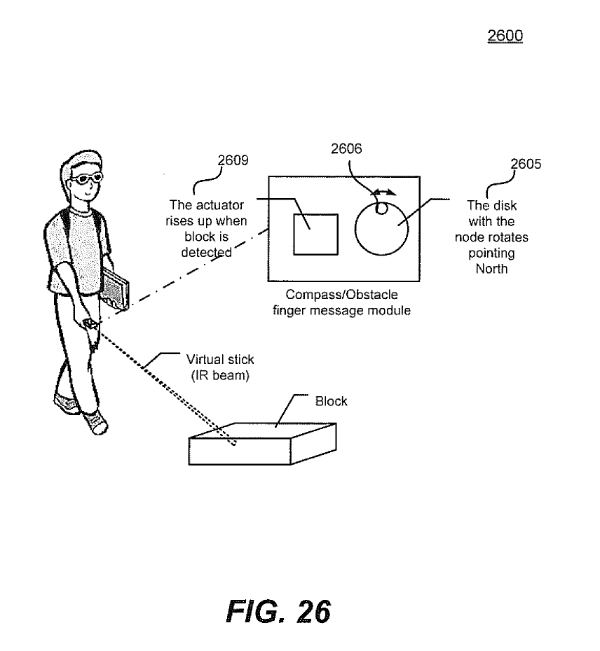

Also, the feedback data of this calculation may be relayed to the user audibly, or via the exemplary compass/obstacle finger message module 2500. The movements of the exemplary message module 2500 are straightforwardly translatable to the obstacle or block in the user's path. For example, if a block is encountered, as depicted in FIG. 26, the obstacle actuator 2609 will rise from the rest or reset position (flush with the face of the device). The compass indicator disk 2605 (a raised or protruding tactile indicator) may also rotate to point the finger tactile node 2606 to North to show that the raised obstacle is directly in the user's path. Similar rising of the actuator will occur when a block or obstacle is encountered.

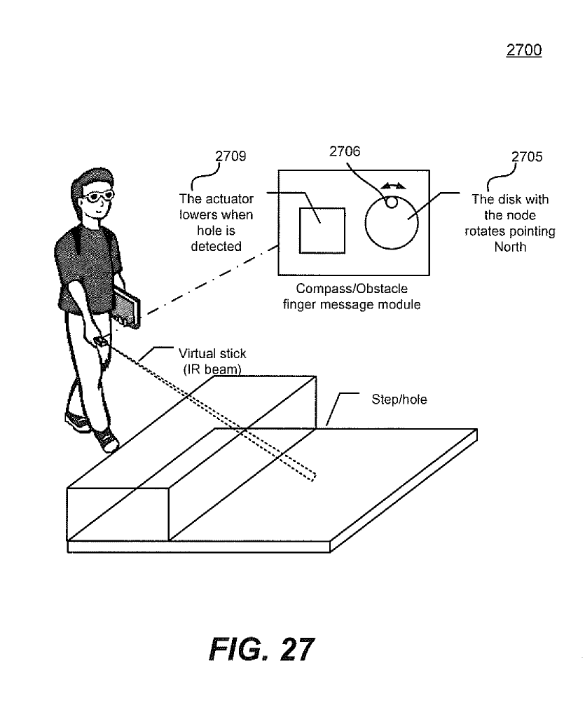

Alternatively, if a descending step or hole is encountered, the obstacle actuator will lower from the rest or reset position (flush with the face of the device). FIG. 27 depicts the walking aid function in use (recognition of a step or hole) wherein the obstacle actuator 2709 is lowered relative to the other features of the exemplary compass/obstacle finger message module 2700; the compass indicator disk 2705 (a raised or protruding tactile indicator) may also rotate to point the finger tactile node 2706 to North to show that the step or hole is directly in the user's path.

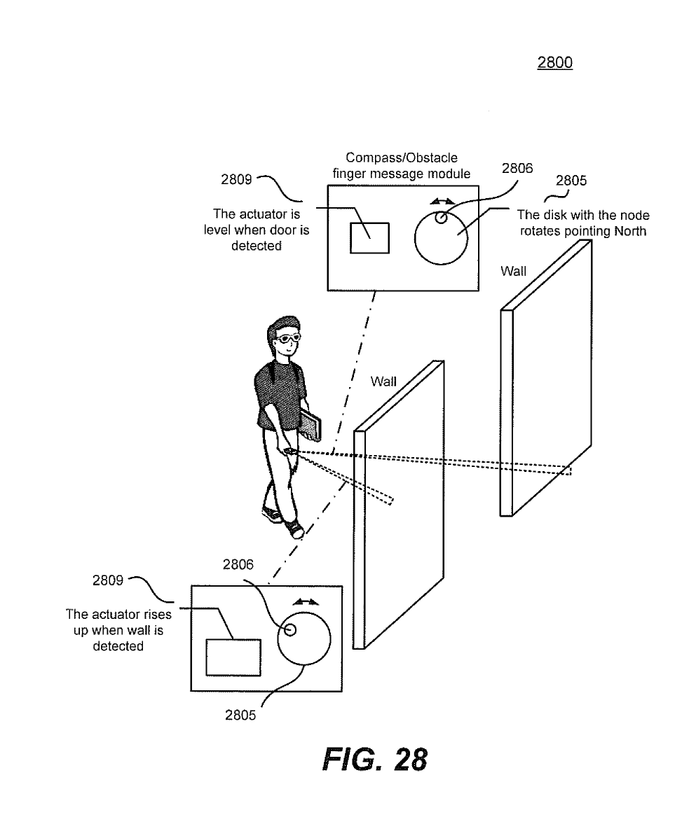

The obstacle recognition feature may also be used when the exemplary device is parallel to the floor, to detect obstacles directly in front of the user. In this application, seen for example in FIG. 28, the reset or rest position of the obstacle actuator 2809, flush with the face of the exemplary compass/obstacle finger message module 2800, corresponds to free space in front of the user. In this example, the compass indicator disk 2805 (a raised or protruding tactile indicator) may also rotate to point the finger tactile node 2806 to North to show that the free space is due North of/in the user's path. If a door is detected, the obstacle actuator 2809 will rise from the rest or reset position. For example, if the user pivots the direction of the beam, perhaps to check the width of the opening space, and a surface (i.e. wall or door) is encountered, the obstacle actuator 2809 would rise from the rest or rest position, and the compass indicator disk 2805 (a raised or protruding tactile indicator) may also rotate to point the finger tactile node 2806 to North to show that the wall or door obstacle is in a direction Northeast of/in the user's path.

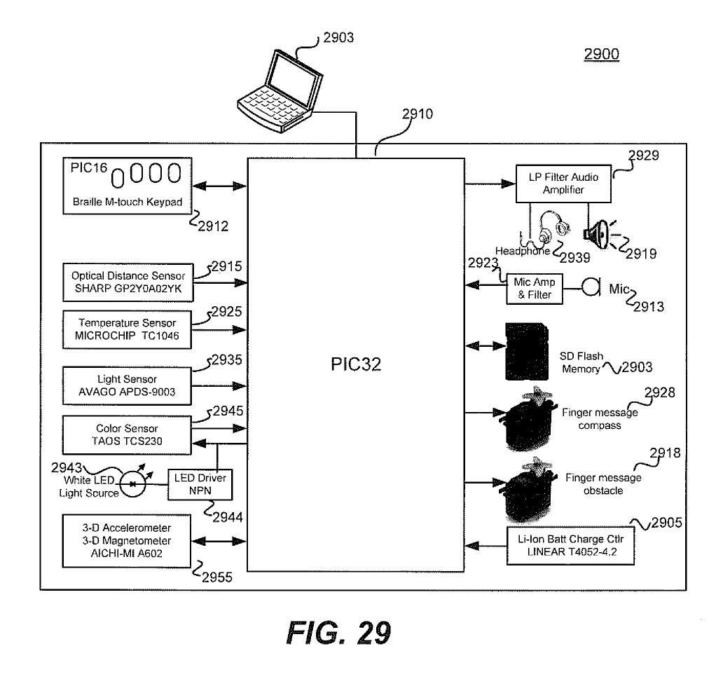

FIG. 29 shows a block diagram of an exemplary embodiment 2900 comprising a processor 2910 (for example, microcontroller Microchip® PIC32) that may receive user input via a finger gesture input unit 2912 (for example, Braille M-touch keypad on a Microchip® PIC16), a microphone 2913 for audio input, and further data input from sensor unit(s) including one or more unit(s) selected from distance sensor 2915 (for example, Sharp® GP2Y0A02YK), temperature sensor 2925 (for example, Microchip® TC1046), light sensor 2935 (for example, Avago APDS-9003), color sensor 2945 (for example, TAOS TCS230), and separate or combined motion sensor and navigation sensor 2955 (for example, combined 3-D accelerometer and 3-D magnetomer, e.g. Aichi Micro Intelligent Corp. AICHI-MI A602). A white LED light source 2943 and LED driver 2944 (for example, NPN configuration) may be connected to the color sensor 2945. The designation of finger gesture user input unit 2912 as input is arbitrary as the finger gesture user input unit 2912 may both transmit data to and receive data from the microcontroller 2910. Singular output components such as finger tactile actuator unit 2918 (for example, finger message obstacle), finger tactile compass actuator unit 2928 (for example, finger message compass), speaker(s) 2919, and headphone 2939 are connected directly or indirectly to microcontroller 2910. It is noted that although singular input components 2912, 2913, 2915, 2925, 2935, 2945 and 2955 and singular output components 2918, 2928, 2919 and 2939 are shown, each of these components can employ more than one input or output unit on the system 2900, where such additional components can also be adapted for data input or output described herein.

The microcontroller 2910 can be powered by external power or a rechargeable battery (not shown), controlled by a battery charge controller 2905 (for example, Li-Ion battery charge controller Linear T4052-4.2). The microcontroller 2910 processes the data input and stores the data using inherent internal memory (not shown) or external memory 2903 (for example flash memory, e.g. SanDisk memory card) (performing read/write operations) and may output the data via user feedback unit(s) finger tactile obstacle actuator unit 2918, a finger tactile compass actuator unit 2928, and more conventional audio output in the form of a headphone 2939 or speaker(s) 2919 and so forth. For audio clarity, as shown, the audio signals from the microphone 2913 may be processed by a microphone amplifier and filter 2923 before being input to the microcontroller 2910. Conversely, the audio output signals may be passed through a low pass filter and audio amplifier 2929 to increase output clarity before being output through the headphones 2939 and/or speaker(s) 2919. The exemplary embodiment 2900 may be connected to a computer 2903 for testing, troubleshooting, software update, file uploading/downloading, etc.

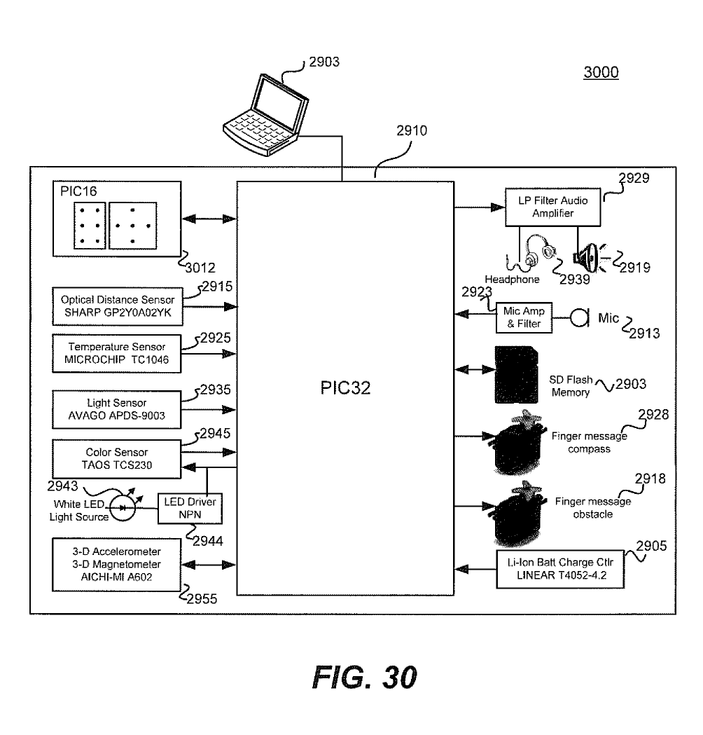

FIG. 30 shows a block diagram of another exemplary embodiment 3000 similar to that of the exemplary embodiment of FIG. 29, wherein the processor 2910 may receive user input via a finger gesture input unit 3012 (for example, Braille finger gesture pad on a Microchip® PIC16).

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Of course, those skilled in the art will recognize many modifications may be made to this configuration without departing from the scope or spirit of what is described herein. It will be understood that many additional changes in the details, materials, steps and arrangement of parts, which have been herein described and illustrated to explain the nature of the subject matter, may be made by those skilled in the art within the principle and scope of the disclosure as expressed in the appended claims. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An assistive device for the visually handicapped, comprising:
a processor;
a portable power source coupled to the processor;
a Braille character touchpad connected to the processor for inputting data, comprising:
a first column area containing three substantially linearly arranged finger responsive areas, the arrangement spatially corresponding to column representations of a Braille character; and
a second column area adjacent to the first column area containing one finger responsive area offset from the three substantially linearly arranged finger responsive areas, the one finger responsive area operating to indicate a null column action for the column representations of a Braille character,
wherein a Braille character is input by selectively engaging at least one area of the three substantially linearly arranged finger responsive areas and the one finger responsive area.

2. The device of claim 1, further comprising a distance determining transmitter and receiver unit, operable to provide information on a distance of an object relative to a position and orientation of the device.

3. The device of claim 2, further comprising a tactile feedback navigation unit, comprising:
a magnetic field sensor;
an acceleration sensor;
a direction unit containing an rotatable elevated direction indicator which is automatically rotated to a pre-determined compass direction; and
an obstacle unit containing a vertically adjustable obstacle indicator which is automatically raised or lowered to determine an obstacle elevation in a vicinity of the device.

4. The device of claim 1, further comprising a color sampling unit, comprising:
a light emitter;
a color sensor displaced from the light emitter; and
a protective chamber disposed about the light emitter and color sensor, operating to allow light from the emitter to be reflected from an object placed in a vicinity of the chamber and received by the color sensor.

5. The device of claim 1, further comprising at least one of a power charging port, an external communication port, a microphone, a speaker, an audio output jack, and a temperature sensor.

6. The device of claim 1, wherein the device is a handheld portable device.

7. An assistive device for the visually handicapped, comprising:
a processor;
a portable power source coupled to the processor;
an input pad connected to the processor for inputting, comprising:
a Braille touchpad containing six finger responsive areas arranged in two columns, the arrangement spatially corresponding to first and second column representations of a Braille character; and
a touch gesture pad adjacent to the Braille touchpad, containing a plurality of finger and gesture responsive areas,
wherein a Braille character is input by selectively engaging at least one of the six finger responsive areas of the Braille touchpad and the plurality of finger and gesture responsive areas of the gesture pad, and
wherein at least one of a word processing and command action is initiated by selectively engaging the plurality of finger and gesture responsive areas of the gesture pad.

8. The device of claim 7, further comprising a distance determining transmitter and receiver unit, operable to provide information on a distance of an object relative to a position and orientation of the device.

9. The device of claim 8, further comprising a tactile feedback navigation unit, comprising:
a magnetic field sensor;
an acceleration sensor;
a direction unit containing an rotatable elevated direction indicator which is automatically rotated to a pre-determined compass direction; and
an obstacle unit containing a vertically adjustable obstacle indicator which is automatically raised or lowered to determine an obstacle elevation in a vicinity of the device.

10. The device of claim 7, further comprising a color sampling unit, comprising:
a light emitter;
a color sensor displaced from the light emitter; and
a protective chamber disposed about the light emitter and color sensor, operating to allow light from the emitter to be reflected from an object placed in a vicinity of the chamber and received by the color sensor.

11. The device of claim 7, further comprising at least one of a power charging port, an external communication port, a microphone, a speaker, an audio output jack, and a temperature sensor.

12. The device of claim 7, wherein the device is a handheld portable device.

13. A method of Braille character entry on a touch sensitive input pad, comprising:
a first pressing of at least one area of three substantially linearly arranged finger responsive areas and a single finger responsive area offset from the three substantially linearly arranged finger responsive areas; and
a second pressing of at least one area of the three substantially linearly arranged finger responsive areas and the single finger responsive area offset from the three substantially linearly arranged finger responsive areas,
wherein an arrangement of the first pressing corresponds to a first column representation of a Braille character and an arrangement of the second pressing corresponds to a second column representation of the Braille character,
wherein a null column action is registered if the single finger responsive area is pressed.

14. A method of Braille character or command entry on a touch sensitive input pad, comprising:
first pressing at least one of six Braille format arranged finger responsive areas on a touchpad; and
second pressing a gesture pad to terminate entry of the Braille character or gesturing on the gesture pad to initiate a command.

15. The method of claim 14, wherein the command is at least one of reading notes, telling time, temperature, date, object color, controlling a music player, and opening a folder or file.

16. The method of claim 14, wherein the command is a word processing command.

17. An assistive device for the visually handicapped, comprising:
means for computing;
means for providing power;
means for inputting finger motions, comprising:
a first column area containing three substantially linearly arranged finger responsive areas, the arrangement spatially corresponding to column representations of a Braille character; and
a second column area adjacent to the first column area containing one finger responsive area offset from the three substantially linearly arranged finger responsive areas, the one finger responsive area operating to indicate a null column action for the column representations of a Braille character,
wherein a Braille character is input by selectively engaging at least one area of the three finger responsive areas and the one finger responsive area.

18. The device of claim 17, further comprising means for determining a distance of an object relative to a position and orientation of the device.

19. An assistive device for the visually handicapped, comprising:
means for computing;
means for providing power;
means for inputting finger motions, comprising:
six finger responsive areas arranged in two columns, the arrangement spatially corresponding to first and second column representations of a Braille character; and
a plurality of finger and gesture responsive areas adjacent to the six finger responsive areas,
wherein a Braille character is input by selectively engaging at least one of the six finger responsive areas and the plurality of finger and gesture responsive areas, and
wherein at least one of a word processing and command action is initiated by selectively engaging the plurality of finger and gesture responsive areas.

20. The device of claim 19, further comprising means for determining a distance of an object relative to a position and orientation of the device.
